(19) United States
(12) Patent Application Publication
(10) Pub. No.: US 2018/0143345 A1
(43) Pub. Date: May 24, 2018

(54) OPTOELECTRONIC SENSOR AND METHOD FOR MONITORING A MONITORED ZONE

(71) Applicant: SICK AG, Waldkirch (DE)

(72) Inventor: Axel JAHN, Waldkirch (DE)

(21) Appl. No.: 15/800,176

(22) Filed: Nov. 1, 2017

(30) Foreign Application Priority Data
Nov. 21, 2016 (DE) 102016122364.6

(51) Int. Cl. G01V 8/10; F16P 3/14; G01B 11/02; G01C 3/06

(52) U.S. Cl. CPC G01V 8/10; G01C 3/06; G01B 11/026; F16P 3/144

(57) ABSTRACT

An optoelectronic sensor (10), in particular a light grid, for monitoring a monitored zone (22) is provided, wherein the sensor has at least one light transmitter (14) for transmitting a monitoring beam (20), at least one light receiver (18) for receiving the monitoring beam (20) and for generating a corresponding received signal, and an evaluation unit (26) to recognize from the received signal whether the monitoring beam (20) is interrupted and to output an interruption signal on a recognition of an unauthorized interruption of the monitoring beam (20). The light receiver (18) is configured in this respect such that the received signal is dependent on the geometry of the light spot (30) generated at the light receiver (18) by the monitoring beam (20) and the evaluation unit (26) is configured to recognize from the received signal whether the non-interrupted monitored beam (20) is manipulated.

The invention relates to an optoelectronic sensor, in particular a light grid, for monitoring a monitored zone, wherein the sensor has at least one light transmitter for transmitting a monitoring beam, at least one light receiver for receiving the monitoring beam and for generating a corresponding received signal, and an evaluation unit to recognize from the received signal whether the monitoring beam is interrupted and to output an interruption signal on a recognition of an unauthorized interruption of the monitoring beam, and to a method for monitoring a monitored zone.

A large group of optoelectronic sensors is based on the recognition of a beam interruption. Light barriers only monitor spots in one dimension, while an areal monitoring also becomes possible using a light grid that practically comprises a plurality of light barriers. One sector of use is automation where the beam interruption triggers an event such as a machining step or an expulsion from a conveying stream and where a light grid can carry out a vertical measurement. Light grids are also in particular frequently used to protect danger zones from intrusions. It can, for example, be a machine such as a press whose workstep has to be stopped immediately when an operator comes too close to the machine. The light grid in this context forms a virtual wall whose touching generates a warning signal, usually directly a shutdown signal.

The comparatively simple detection principle opens up possibilities to manipulate the sensor intentionally or accidentally and thus to displace the actual monitored zone in an unrecognized manner. This in particular may not take place in safety engineering since then injuries are no longer reliably prevented. Safety standards such as IEC 61496-2 therefore additionally prescribe ensuring that light does not accidentally reach the light receiver by another path than the direct path. This can take place by means of a reflection bypass by a reflective surface outside the monitored zone or by other optical elements such as light guides. Such manipulations of the monitored field such as reflection bypass or beam offset by suitable optical components and structures cannot be determined in a simple and inexpensive manner.

A typical measure is the observation of very small opening angles at the transmission side and at the reception side, for example with the aid of diaphragms. However, this has the disadvantage that a correspondingly exact adjustment is necessary that makes the installation very complex. The difficulty of the adjustment is increased when infrared light is used so that the beams are not visible. EP 1 947 481 B1 proposes only restricting the opening angle at the reception side, but to do so to a particularly high degree. This makes the light grid secure from bypass reflection in the sense of the safety standards, but does not reveal the manipulation itself.

EP 0 875 873 B1 proposes a spatially resolving light receiver to increase the security from bypass reflection, with the desired position of the received light at the light receiver being determined in a teaching process. The sensor switches when the reception position differs too far in operation from this desired position because it is assumed that light received with such an offset is not received on a direct path, but rather after a bypass reflection and that the direct path is blocked by an object. This is not sufficient with respect to some manipulations, for example with a plurality of mirrors in which the reception position does not differ from the desired position at all.

Light grids are also known that measure the distance in addition to the beam monitoring. A manipulation could thus be revealed by the change of the path distance that the light covers on the monitoring beam. However, an exact synchronization between the transmitter and the receiver is necessary for such a measurement. The transmission unit and reception unit are, however, typically not electrically connected to one another and such a synchronization is not simply possible.

A detector is, for example, known from WO 2012/110924 A1 without any reference to light grids that can measure a distance from the focal position. This detector is based on a special effect, for example, in organic solar cells whose output signal has a dependence on the geometry of the light spot on the solar cell despite the same incident light amount. This effect is also called a FiP effect (an abbreviation for the beam cross-section Φ and the electrical power P) and the detector is correspondingly called a FiP sensor.

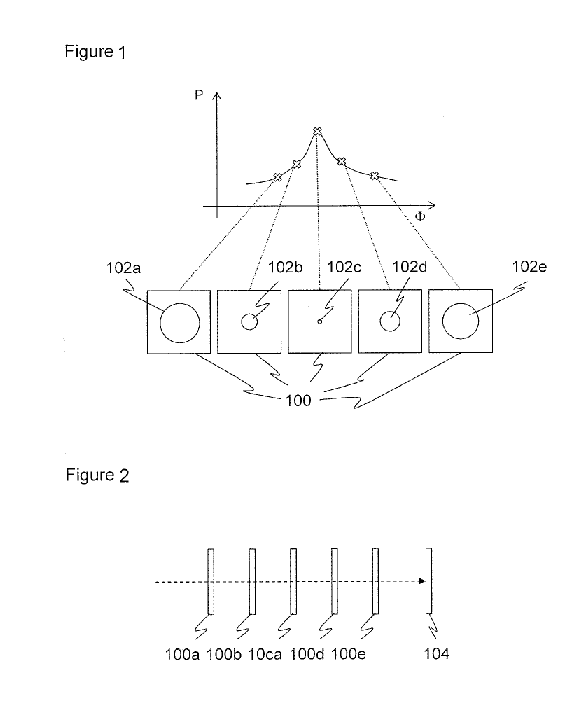

The measurement principle will be explained with reference to FIG. 1. Reference is made to WO 2012/110924 A1 for further details, in particular suitable materials and specific embodiments of a FiP sensor. In the lower part, FIG. 1 shows the detector surface of a FiP sensor 100 in a plan view in a plurality of situations, five here by way of example, with a light spot 120a-e of different sizes. The light spot a-e is generated by a light beam incident via a reception optics and varies with the distance of the generating light source due to the different focal positions. In addition, the light spot 102a is therefore first scattered relatively far with a small distance, but then becomes a small light spot 102c via a light spot 102b becoming smaller with a focused imaging and then again becomes a larger light spot 102d-e with an increasing distance.

The integrated incident light intensity here is the same at all distances and therefore not a suitable measurement parameter for a distance determination. The signal of the FiP sensor 100 is, however, dependent on the geometry, that is in particular on the diameter of the light spot 102a-b. This is illustrated in the upper part of FIG. 1 in which the output power P of the FiP sensor 100 is shown in dependence on the beam cross-section Φ. The five situations illustrated at the bottom having different light spots 102a-e are entered as measurement points therein. A clear maximum results at the smallest beam cross-section, with a corresponding drop to both sides. If this characteristic is known, a distance can be measured with reference to the current power over the beam cross-section and the focal position. With a conventional detector, a flat characteristic would be expected, in contrast to FIG. 1, since the received signal conventionally only depends on the incident light amount. The FiP effect in another respect still shows a dependence on the modulation frequency of the transmitted light which will not be looked at in more detail here.

US 2014/0291480 A1 discloses a further development of the FiP sensor. In this respect, a plurality of partly transparent FiP sensors 100a-e are arranged behind one another as in a stack. The light spots 102a-e originating from different situations in FIG. 1 can also be understood as those in one and the same measurement on the FiP sensors 100a-e of FIG. 2 when the reception optics focuses a light source sharply on the middle FiP sensor 100c. The signal distribution over the FiP sensors 100a-e can therefore be evaluated to determine the focal position and, from this, the distance. The advantage of the stack arrangement is that the plurality of simultaneous measurements allow a relative comparison that provides an independence from variable influences such as the strength of the light source, extraneous light, and the like.

In addition, a spatially resolving light receiver 104 is provided in FIG. 2. It is shown at the end of the stack arrangement, but could also be arranged partially transparent and further to the front. A lateral position can also be measured via the spatially resolving light receiver 104 in addition to the distance.

As already mentioned, WO 2012/110924 A1 and US 2014/0291480 A1 do not deal with light grids, but are rather directed to a 3D camera. Interrupted monitoring beams or especially their manipulation do not play any role there.

It is the object of the invention to improve the manipulation recognition in a sensor of the category with a recognition of beam interruptions.

This object is satisfied by an optoelectronic sensor and by a method for monitoring a monitored zone in accordance with the respective independent claim. The sensor spans a monitored beam, preferably a plurality of monitoring beams as a light grid, using at least one light transmitter and light receiver in the manner of a one-way light barrier or a reflection light barrier. An evaluation unit recognizes interruptions of the monitoring beam, with not all interruptions being non-permitted such as with a direct muting. An interruption signal is then output.

The invention now starts from the basic idea of using a light receiver that shows the dependence of the received signal on the geometry in accordance with the FiP effect. Information on the light spot generated at the light receiver by the monitoring beam is thus detected in the received signal. The dependence on the geometry of the light spot can also be expressed such that the light receiver is sensitive to the energy density of the incident light. In illustrative terms, the received signal also changes when only the geometry of the light spot changes, in particular its surface area or diameter, even with a constant overall energy or quantity of light of the incident monitoring beam. This dependence preferably comprises one and the same light reception element, that is light is not distributed over a plurality of pixels of a receiver matrix.

The additionally acquired information of the received signal is then used for a manipulation recognition. Targeted and unintentional disturbances are in this respect called manipulation in simple terms, that is, for example, the reflection bypassing using separately set up reflectors or light guides, but also an unintentional reflection bypass by a shiny surface or by a maladjustment by a collision with the sensor. A monitoring beam manipulated in this manner is not recognized as interrupted for sufficient light still reaches the light receiver to exceed a reception threshold, for example. It is rather recognized whether the light spot changes its geometry due to a manipulation, which the light receiver used can reveal because its received signal actually does not only depend on the incident quantity of light, but also on the geometry.

The invention has the advantage that further detector information is available with the geometry in addition to the reception intensity. Manipulations of a sensor can thus be revealed in an inexpensive and reliable manner. The light receiver sensitive to geometry properties is inexpensive and at the same time delivers valuable additional information that makes a safe recognition of bypass reflections and further manipulations possible.

The evaluation unit its preferably configured to determine a length of the light path of the monitoring beam from the received signal and to recognize a manipulation with reference to a change of the length. The light spot differs due to the focal position and therefore allows a distance estimate. If a light transmitter is consequently no longer at the same distance, this is recognized as a manipulation, with a certain tolerance being able to be permitted. As a rule, the monitoring beam extends directly in normal operation so that any manipulation extends the light path; however, a shortening would also be recognized. Only one light receiver per monitoring beam is required for the distance measurement, unlike with a stereoscopic distance measurement, for example.

The light receiver preferably has a plurality of partly transparent light reception elements one after the other, with the respective received signal of a light reception element being dependent on the geometry of the light spot generated at the light reception element by the monitoring beam. This light receiver consequently utilizes a stack arrangement or an arrangement one after the other as explained in the introduction with reference to FIG. 2. A substantially more precise evaluation of the geometry information is thereby made possible. A teaching of an absolute characteristic describing the FiP effect that would not be robust under variable environmental conditions is no longer necessary.

The light receiver preferably has at least one light reception element that determines a lateral position of the light spot. This spatially resolving light reception element can, for example be a PSD (position sensitive element) or a pixel-resolved receiver matrix. The arrangement can preferably be at the front or at the rear, but also at another position of a stack of light reception elements with a received signal dependent on the geometry of the light spot. The distance information is thus supplemented by a lateral position determination. The geometry of the light spot, in particular a distance of the light transmitter, the position of the light spot, in particular the direction of incidence of the monitoring beam, and the reception intensity are now available as pieces of detector information for a recognition of a beam interruption and manipulation.

The evaluation unit is preferably configured to recognize a manipulation from a change of the lateral position of the light spot. A manipulated monitoring beam as a rule is not incident at the same point as the actually desired direct monitoring beam. The evaluation of both a geometry change and a change of the lateral position, especially both a distance change and a direction change, is particularly reliable.

The evaluation unit is preferably configured to teach the received signal to be expected without manipulation in a teach-in phase and to store it as a reference. This not only relates to the reception intensity and to reception thresholds derived therefrom to recognize beam interruptions. The geometry of the light spot, in particular a desired distance of the light transmitter, and optionally its lateral position and thus the direction of incidence, is thus also taught.

The light transmitter is preferably configured to modulate the light of the transmitted monitoring beam. Such a modulation first supports the FiP effect that, as mentioned in the introduction, depends on the modulation frequency. A suitable modulation for a sufficiently strong FiP effect should therefore be selected. The modulation can, however, also be used for beam coding so that a light receiver recognizes the light transmitter associated with it with reference to the monitoring beam. Finally, a modulation also serves for interference suppression, for example by lock-in amplification to the known modulation frequency or the ignoring or filtering of CW light portions. A simple modulation by a carrier frequency can also be superposed or replaced with a real coding.

The light receiver preferably has at least one organic or inorganic solar cell. Such solar cells (DSC, dye sensitized solar cell) show a pronounced FiP effect. Reference is again made to WO 2012/110924 A1 with respect to the specific embodiment, with the light receive and specifically the solar cell not being restricted to the possibilities described there. It is ultimately only important that the FiP effect occurs in the light receiver used.

The light receiver or a reception optics of the light receiver preferably has an opening angle that is greater than demanded by safety standards for observing the bypass reflection safety. The standard limits the opening angle to avoid an unwanted bypass reflection by shiny surfaces. The security from bypass reflection is, however, ensured in a different manner in accordance with the invention. Greater opening angles at the transmission and/or reception side thereby become possible and the sensor can therefore be adjusted particularly simply.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

FIG. 1 a representation of the received signal for different geometries of light spots on a light receiver to explain the FiP effect;

FIG. 2 a schematic representation of a further development of a FiP sensor as a stack arrangement;

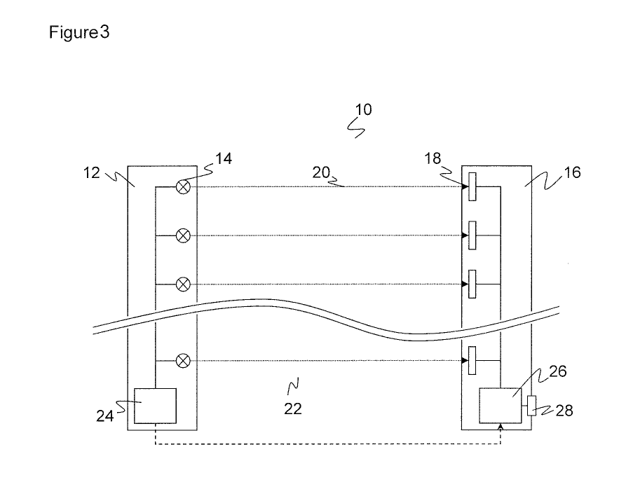

FIG. 3 a schematic representation of a light grid;

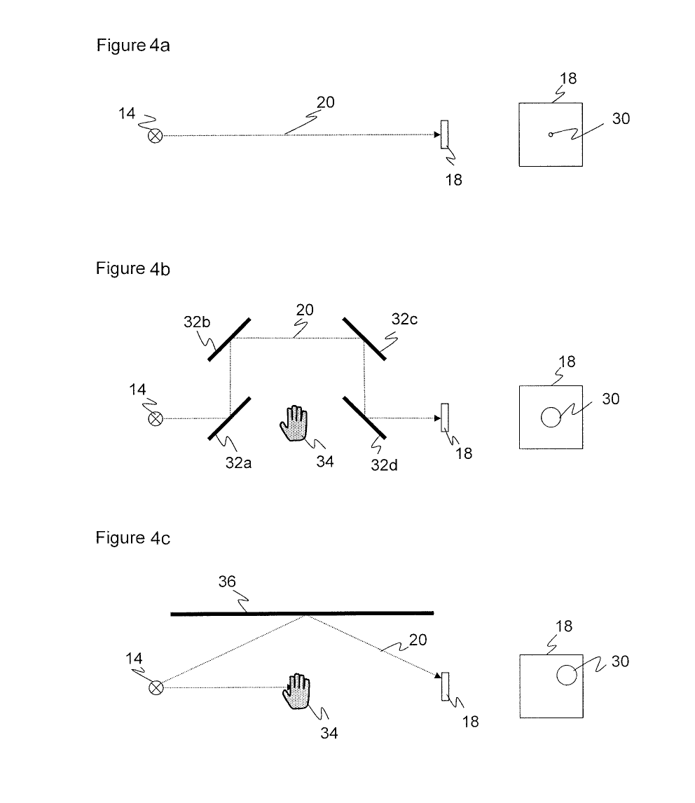

FIG. 4a a schematic representation of a monitoring beam without manipulation with an associated light spot at the light receiver;

FIG. 4b a schematic representation of a monitoring beam manipulated by a plurality of deflection mirrors with an associated light spot at the light receiver; and

FIG. 4c a schematic representation of a monitoring beam bypass-reflected by a shiny surface with an associated light spot, also laterally displaced, at the light receiver.

FIG. 3 shows a schematic sectional representation through a light grid 10. A transmission unit 12 having a plurality of light transmitters 14 and a reception unit 16 having a plurality of light receivers 18 are arranged disposed opposite one another. A transmission optics or reception optics that is mostly not separately mentioned in the following can be associated with the light transmitters 14 and the light receivers 18. A respective light beam or monitoring beam 20 is transmitted from the light transmitters 14 to an associated light receiver 18. The light grid 10 thus spans a plurality of monitoring beams 20 to recognize objects in a monitored zone 22 between the transmission unit 12 and the reception unit 16.

The light receivers 18 are thus configured such that their received signals is dependent on the geometry of a light spot that is generated by the monitoring beam 20. The light receivers 18 are therefore FiP sensors. In this respect, the different embodiments are conceivable that were explained in the introduction with reference to FIGS. 1 and 2 and additionally also further embodiments in accordance with WO 2012/110924 A1 or US 2014/0291480 A1 are possible. The evaluation of the geometry information accessibly by the FiP effect is used in accordance with the invention for a manipulation recognition that will be explained in more detail further below with reference to FIGS. 4a-c.

A transmission control 24 is provided in the transmission unit 12 to control the activity of the light transmitters 14. An evaluation unit 26 is provided as a counterpart in the reception unit 16 to evaluate the received signals. The evaluation unit 26 recognizes with reference to the received signals which monitoring beams 20 are interrupted and which are not. A corresponding output signal is provided at an output 28. It can here, for example, be a binary object determination signal, a vertical measurement signal, information on which monitoring beams 20 are infringed or raw or preprocessed received signals. The output 28 is specifically a safe output (OSSD, output signal switching device) in safety engineering in the sense of the safety standards for the output of a safety-directed shutdown signal to switch a hazard source into a safe state on a recognized object intrusion. The evaluation unit 26 is shown in FIG. 3 as a central, common evaluation unit to which the received signals of the individual light receivers 18 are supplied, for example in a time multiplex process. Alternatively, a plurality of evaluation units can be provided for individual monitoring beams 20 or for groups of monitoring beams 20.

Unlike the simplified representation in FIG. 3, the monitoring beam 20 radiates over a plurality of light receivers 18 in most practical cases. For this reason, a respective only one pair of a light transmitter 14 and the associated light receiver 18 is frequently operated simultaneously by the monitoring beams in a cyclic process. These cycles have to be synchronized between the transmission unit 12 and the reception unit 16, as is indicated by a dashed line. The synchronization can admittedly also be wired, but is preferably synchronized in an optical manner. This is simply possible because only the start of an evaluation cycle has to be synchronized.

In addition, the monitoring beams are preferably transmitted and received with a modulation. This has a plurality of reasons: First, the FiP effect depends on the modulation frequency so that a suitable modulation frequency is set to achieve a sufficient geometry dependence of the received signal. The modulation can furthermore be varied per monitoring beam 20, in particular by different modulation frequencies or by an individual coding superposed on a modulation frequency and can thus be used as an alternative or additional criterion so that the evaluation unit 26 recognizes the light transmitter 14 associated with a respective light receiver 18 and ignores light of other light transmitters 14. This can be taught on the putting into operation, for instance. Finally, interference sources, in particular CW light portions, can also be filtered out of the measurement signal by modulation.

The light grid 10 is an example of an optoelectronic sensor in which the manipulation recognition in accordance with the invention can be used particularly advantageously. The invention is, however, not restricted to this and can also be used for other optoelectronic sensors such as one-way light barriers or reflection light barriers and light scanners. In addition, the light grid 10 is shown with a purely transmission unit 12 and a purely reception unit 16 in which each respective light transmitter 14 is associated with exactly one light receiver 18. This is particularly simple and is frequently utilized in this manner, but can also be varied in other embodiments, either by mixed transmission and receiver units, a scanning system having light transmitters and light receivers at the same side and at a passive counter-side or a deviation of the direct association, for example by beam splitting, whereby a numerical imbalance with more light transmitters or more light receivers can then result.

The manipulation recognition will now be explained with the aid of the light receivers 18 formed as FiP sensors with reference to FIGS. 4a-c.

FIG. 4a first shows a direct, non-manipulated monitoring beam 20. In this respect, only a single monitoring beam 20 is shown to simplify the illustration. As can be seen at the right in the representation of the light spot 30 generated at the light receiver 18 by the monitoring beam 20, the light grid 20 is preferably set such that the light spot 30 is focused by the reception optics in this situation and is therefore small. This produces a correspondingly high, unambiguously detectable signal in the normal state with respect to the FiP effect shown in FIG. 1. Such a normal state with a small light spot 30 is, however, not necessary. The normal state is preferably determined with the all the required information on the received signal and on the light spot 30 in a teach-in phase and is stored as a later reference.

FIG. 4b shows a manipulation by four deflection mirrors 32a-d. The number and the arrangement of the deflection mirrors 32a-d are naturally purely by way of example and other manipulations by light guides and further optical elements are also possible. An object 34 intruding without permission no longer interrupts the monitoring beam 20 and can therefore not be detected. This is a risk that is to be avoided at all costs, particularly in a technical safety application, since the protection is effectively disabled. The manipulation shown is relatively complex, but has the result that the monitoring beam 20 is incident at the light receiver 18 from the same direction as a direct monitoring beam 20. The manipulation cannot be discerned by most processes since neither the direction of incidence nor the total intensity at the light receiver 18 changes.

As can, however, be seen at the right in FIG. 4b, the geometry of the light spot 30 has changed, in particular its area or diameter. This change in geometry influences the light receiver 18 formed as a FiP sensor in a measurable manner. As already mentioned, the monitoring beams 20 are by no means perfectly collimated in reality. The cross-section of the monitoring beams 20 therefore varies with the distance. The greater effect that results in geometry changes of the light spot 30 is, however, the focal position because the reception optics focuses in dependence on the distance of the associated light transmitter 14 or increasingly moves out of focus with too great a proximity or distance. It is thus possible to draw a conclusion on the distance from the light transmitter 14 via the focal position or, in other words, the length of the monitoring beam 20 can be measured that has increased due to the bypass reflections. The manipulation is consequently revealed by monitoring the path length.

FIG. 4c shows a further exemplary manipulation, now by a shiny or reflective surface 36. While a manipulation as in FIG. 4b will hardly occur without intent, metal surfaces in the proximity of the light grid 10 are also easily conceivable without a targeted manipulation. In principle, the same occurs as in FIG. 4b. Although the object 34 interrupts the direct monitoring beam 20, transmitted light can still reach the light receiver 18 via a detour over the reflective surface 36.

Unlike the bypass reflection in accordance with FIG. 4b, not only the geometry of the light spot 30 is changed here. The intensity of the incident monitoring beam 20 is also reduced due to the portions blocked on the direct path by the object 34. This is, however, not reliably sufficient on its own for the recognition of a beam interruption; it rather depends on numerous influences such as the choice of threshold, the opening angle, the beam cross-section and the object 34. The direction of incidence of the monitoring beam 20 at the light receiver 18 has rather also changed here. This is shown, as can be recognized at the right in FIG. 4c, in a lateral displacement of the light spot 30 that is likewise detected in a corresponding design of the light receiver 18, for example in accordance with FIG. 2. A combined evaluation of the light intensity, geometry or distance and/or direction of incidence or lateral position therefore produces a particularly reliable manipulation recognition.

The light grid 10 reacts differently to a recognized manipulation depending on the embodiment. In automation applications, a warning can be sufficient, for example in the form of a display or of a piece of information to another system such as a higher ranking control. In safety engineering, a manipulation should be treated like the recognition of an unauthorized object intrusion, namely a safety-directed shutdown signal, with an additional indication of the cause facilitating the subsequent repeat putting into operation.

The manipulation recognition in accordance with the invention also enables a security from bypass reflection that satisfies the standard with larger opening angles of the light transmitters 14 and/or light receivers 18 or of the associated optics. This considerably simplifies the adjustment of the light grid 10. In addition, an electric connection between the transmitter and the receiver is also not necessary for a distance measurement; an optical synchronization of the activation cycles is sufficient.

The light receiver 18 delivers a plurality of pieces of information combined in its received signal. On the one hand, the illumination intensity in the light spot can naturally vary as conventionally. There is, however, also the additional fact of a geometrical change with the same integrated power of the incident monitoring beam 20 of the light spot that can be recognized on the basis of the FiP effect. This can in particular be used for a distance measurement. Finally, the lateral light spot positions is also available in corresponding embodiments with a spatially resolving receiver. A manipulation results in a change of at least one of these pieces of measurement information and is thereby revealed. If the intensity, the focal position and the position do not change in accordance with the taught received signal, superposed interference signals, for instance due to reflections, extraneous light sources or multi-path reception, can also be separated and suppressed.

1. An optoelectronic sensor for monitoring a monitored zone, wherein the optoelectronic sensor has at least one light transmitter for transmitting a monitoring beam, at least one light receiver for receiving the monitoring beam and for generating a corresponding received signal, and an evaluation unit to recognize from the received signal whether the monitoring beam is interrupted and to output an interruption signal on a recognition of an unauthorized interruption of the monitoring beam,
wherein the light receiver is configured such that the received signal is dependent on the geometry of the light spot generated at the light receiver by the monitoring beam; and with the evaluation unit being configured to recognize from the received signal whether the non-interrupted monitored beam is manipulated.

2. The optoelectronic sensor in accordance with claim 1, wherein the optoelectronic sensor is a light grid.

3. The optoelectronic sensor in accordance with claim 1,
wherein the evaluation unit is configured to determine a length of the light path of the monitoring beam from the received signal and to recognize a manipulation with reference to a change of the length.

4. The optoelectronic sensor in accordance with claim 1,
wherein the light receiver has a plurality of partly transparent light reception elements one after the other, with the respective received signal of a light reception element being dependent on the geometry of the light spot generated at the light reception element by the monitoring beam.

5. The optoelectronic sensor in accordance with claim 1,
wherein the light receiver has at least one light reception element that determines a lateral position of the light spot.

6. The optoelectronic sensor in accordance with claim 5,
wherein the evaluation unit is configured to recognize a manipulation from a change of the lateral position of the light spot.

7. The optoelectronic sensor in accordance with claim 1,
wherein the evaluation unit is configured to teach the received signal to be expected without manipulation in a teach-in phase and to store it as a reference.

8. The optoelectronic sensor in accordance with claim 1,
wherein the light transmitter is configured to modulate the light of the transmitted monitoring beam.

9. The optoelectronic sensor in accordance with claim 1,
wherein the light receiver has at least one organic or inorganic solar cell.

10. The optoelectronic sensor in accordance with claim 1,
wherein the light receiver or a reception optics of the light receiver has an opening angle that is greater than demanded by safety standards for observing the bypass reflection safety.

11. A method of monitoring a monitored zone, wherein a monitoring beam is sent from a light transmitter to a light receiver that generates a received signal from it; and wherein the received signal is evaluated to recognize whether the monitoring beam is interrupted and to output an interruption signal on a recognition of an unauthorized interruption of the monitoring beam,
wherein the received signal is dependent on the geometry of a light spot generated at the light receiver by the monitoring beam; and wherein it is recognized from the received signal whether the non-interrupted monitoring beam is manipulated.
